(19) United States
(12) Patent Application Publication
(10) Pub. No.: US 2023/0328193 A1
(43) Pub. Date: Oct. 12, 2023

(54) COLOR MANAGEMENT IN PRINTING

(71) Applicant: Hewlett-Packard Development Company, L.P., Spring, TX (US)

(72) Inventors: Pooshpanjan ROY BISWAS, Sant Cugat del Valles (ES); Alessandro BELTRAMI, Sant Cugat del Valles (ES); Eduardo AMELA CONESA, Sant Cugat del Valles (ES)

(73) Assignee: Hewlett-Packard Development Company, L.P., Spring, TX (US)

(21) Appl. No.: 18/043,059

(22) PCT Filed: Aug. 31, 2020
(86) PCT No.: PCT/US2020/048684

§ 371 Date: Feb. 27, 2023

(51) Int. Cl. H04N 1/60

(52) U.S. Cl. CPC H04N 1/6033

(57) ABSTRACT

A color management method is disclosed. The method comprises printing, on a first side of a separating medium, a plurality of color regions, each region being of a different color of a set of colors; printing, on a second side of the separating medium, for each of the plurality of color regions, a plurality of patches within an area registered with a respective color region, wherein each patch has a different one of the set of colors; and generating, for each of the plurality of color regions, an international color consortium (ICC) profile by characterizing each color region using a spectrophotometer. A machine-readable medium and an apparatus are also disclosed.

### BACKGROUND

Some billboards and signs are intended to be viewed clearly both at day and at night. During the day, the sign is illuminated by daylight from the sun (sometimes referred to as front illumination) while, at night, the sign is illuminated by a light source (sometimes referred to as back illumination). In some examples, the sign may be back-illuminated by a light source positioned behind the sign.

Signs that are to be backlit may be printed onto a substrate using a process sometimes referred to as “sandwich printing”. A back side image that is to be illuminated by a backlight at night may be printed onto the substrate. A layer of white print agent may then be printed onto the substrate to completely cover the first image. A front side image, that is to be viewed clearly in daylight, is then printed onto the layer of white print agent. At night, when the sign is backlit, the image that is viewed is a combination of the front side image and the back side image.

### BRIEF DESCRIPTION OF DRAWINGS

Examples will now be described, by way of non-limiting example, with reference to the accompanying drawings, in which:

FIG. 1 is an illustration of a color characterization technique;

FIG. 2 is a flowchart of an example of a method of color management;

FIG. 3 is a flowchart of a further example of a method of color management;

FIG. 4 is an illustration of applying generated color profiles to an image according to an area-based method;

FIG. 5 is an illustration of applying generated color profiles to an image according to a pixel-based method;

FIG. 6 is a schematic illustration of an example of a machine-readable medium in communication with a processor; and

FIG. 7 is a schematic illustration of an example of an apparatus.

### DETAILED DESCRIPTION

Billboards or signs that are intended to be viewed both during the day and at night using backlighting are sometimes referred to as “day and night” signs or “D&N” signs. According to a first approach, a first, or “front”, image (e.g. an advertisement) may be printed on the front side of a printable substrate or printable media, and a second, or “back”, image may be printed on the back side of the substrate or media. In this case, the printable substrate may be referred to as a separating medium as it separates the front image from the back image. According to a second approach, the back image may be printed onto a printable substrate, a layer of white print agent may be printed over the back image, and the front image may be printed onto the layer of white print agent. In this case, the layer of white print agent may comprise the separating medium as it separates the front image from the back image. In some cases, the images to be printed on the front side and the back side of the printable substrate may be identical while, in other cases, different images may be printed on the front side and the back side. The printable substrate or the layer of white print agent may be semi-transparent, such that, when the substrate is back-illuminated, a combination of the images on the front and back sides of the substrate is visible to a viewer.

In examples where the front image and the back image are different, when the images are backlit, a viewer sees a combination of the front image and the back image, and the colors that are visible may also represent a combination of colors used in the front image and the back image which may lead to the viewer seeing colors different from those originally intended in the billboard or sign. It has been recognized that, by using the color characterization techniques described herein, color profiles may be generated for a wide range of possible color combinations resulting from the combination of a front image and the back image. Examples disclosed herein relate to generating such profiles, and other examples relate to applying the profiles to images to be printed.

Examples generate color profiles meeting a particular standard, referred to as ICC profiles. In the context of color management, an ICC profile is a set of data that characterize a color input or output device, or a color space, according to standards promulgated by the International Color Consortium (‘ICC”). In one example, an ICC profile describes the color attributes of a particular device or viewing requirement by defining a mapping between the device source or target color space and a profile connection space (“PCS”). This PCS is either CIELAB (L*a*b*), wherein three variables represent lightness (‘L’) and opposing color dimensions (‘a’ and ‘b’), CIEXYZ, wherein three variables (‘X’, ‘Y’ and ‘Z’ or tristimulus values) are used to model a color, or any other color space or derived color space. Mappings may be specified using tables, to which interpolation is applied, or through a series of parameters for transformations. The profile may be generated using, for example, a spectrophotometer.

Prior to printing images using “sandwich printing” techniques, for example in order to create a “day and night” sign, a set of color profiles (e.g. ICC color profiles) may be generated by characterizing a number of possible color combinations occurring as a result of the back illumination of the front image and the back image. In some examples, the side of the separating medium on which the front image is to be printed may be referred to as side A or the front side and the side of the separating medium on which the back image is to be printed may be referred to as side B or the back side.

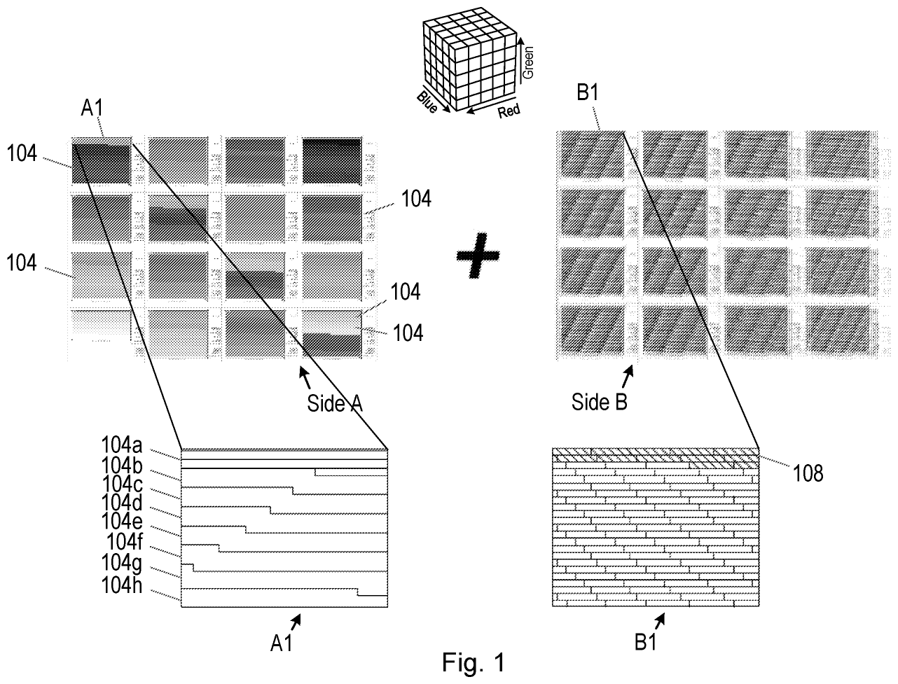

Referring now to the drawings, FIG. 1 is an illustration of color charts used during the characterization of the color combinations. A set of colors is selected for the characterization. In the example shown, colors in the red, green and blue (RGB) color space are used, and a 5-node approach is used to create a uniformly-distributed RGB color cube 102 containing a set of 125 (i.e. 5×5×5=125) colors. In other examples, colors may be used in a different color space, and more or fewer nodes may be used to change the number of colors created in the color cube.

On the front side (e.g. side A) of the separating medium, a plurality of regions 104 of color are printed, each region having a different one of the set of colors. In FIG. 1, the regions 104 of color are shown separated into 16 blocks; however, in other examples, the blocks may be contiguous. For clarity, the block (labelled A1) at the top left corner of side A is shown enlarged, and this block includes regions 104a-h. Each region 104 printed on side A the separating medium comprises a number of color patches equal to the number of colors in the set of colors. Therefore, in the example shown in FIG. 1, each region 104 includes 125 patches of the same color. For example, a region 104a may include 125 patches of a particular shade of cyan, a region 104a may include 125 patches of a particular shade of red, and so on. More generally, for a set of n colors, the front side (i.e. side A) of the separating medium may be printed with n regions, each region having n patches of a particular color of the set of colors. A patch may comprise, for example, a block or area of print agent of a particular color.

On the back side (e.g. side B) of the separating medium, each of the color regions 104, a plurality of color patches 106 are printed within an area on side B that is registered with a respective color region 104 on side A. As with side A, the patches 106 on side B are also shown separated into 16 blocks; however, in examples where the blocks on side A are contiguous, the blocks on side B may also be contiguous. For clarity, the block (labelled B1) at the top left corner of side B is shown enlarged, and this block includes patches 106. Each color patch 106 that is printed within an area registered with a particular color region 104 onside a has a different one of the set of colors. Therefore, in the example shown in FIG. 1, an area labelled 108 on side B is registered with (i.e. appears in a corresponding location as) region 104a printed on side A. In this example, 125 patches 106 are printed within the area 108, each patch having a different one of the set of 125 colors. This is repeated side B for each region 104 printed on side A.

In this way, once all of the color patches 106 have been printed on side B (e.g. the second side or back side) of the separating medium, and all of the color regions 104 have been printed on side A (e.g. the first side or front side) of the separating medium, print agent of each color in the set of colors is printed over (on the opposite side of the separating medium to) print agent of every color in the set of colors, generating a combination of each color in the set of colors with every other color in the set of colors. In the example shown in FIG. 1, therefore, the combinations of color regions 104 on side A with the color patches 106 on side B give rise to 15,625 (i.e. 125×125=15,625) color combinations.

Once the patterns of color have been printed onto the front side and the back side of the separating medium (e.g. either on opposite sides of a printable substrate or separated by a layer of white print agent), a spectrophotometer may be used to characterize each color region 104 and/or each color patch 106. To generate ICC profiles for the color patches 106 on side B, a spectrophotometer may operate in a transmission mode. In a transmission mode, a spectrophotometer may measure transmissive properties of a material (e.g. the printable substrate or the layer of white print agent). Thus, in the example shown in FIG. 1, 125 ICC color profiles are generated. An ICC profile is generated for each combination of colors (i.e. from side A and side B) that may appear through each color region 104 on side A. The ICC profiles include data relating to every possible combination of colors that can be achieved using the set of colors. Each of the 125 ICC profiles generated for the color patches on side B is associated with a color of on side A. The generated ICC color profiles may be applied to an image to be printed on side B of a separating medium to produce a printed image having perceptually more acceptable color and which may use less print agent than a workflow in which standard color profiles are used, which have not been generated using the techniques disclosed herein.

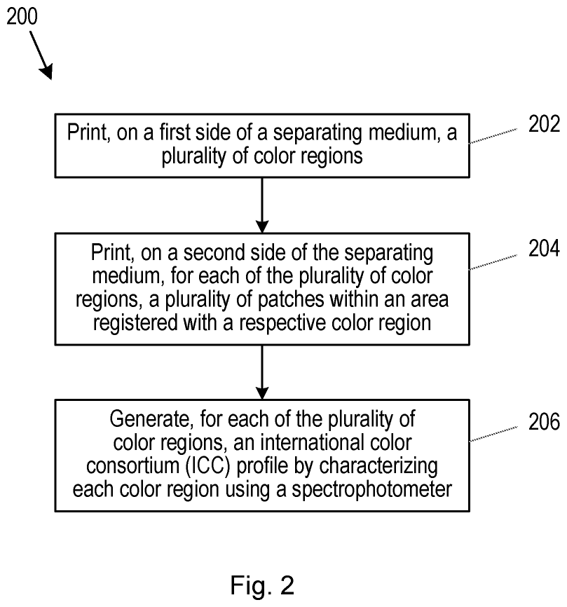

FIG. 2 is a flowchart of an example of a method 200 which may be referred to as a color management method. The method 200 involves parts of the techniques discussed above. The method 200 comprises, at block 202, printing, on a first side (e.g. side A) of a separating medium, a plurality of color regions 104, each region being of a different color of a set of colors. As noted above, each region 104 may comprise a number of patches of the same color, wherein the number is equal to the number of different colors in the set of colors. At block 204, the method 200 comprises printing, on a second side (e.g. side B) of the separating medium, for each of the plurality of color regions 104, a plurality of patches 106 within an area registered with a respective color region, wherein each patch has a different one of the set of colors. Thus, a series of patches 106 is printed behind each color region 104, each patch in the series of patches having each color in the set of colors. The series of patches 106 of the different colors is repeated for each of the color regions 104 printed on the first side of the separating medium.

The method 200 comprises, at block 206, generating, for each of the plurality of color regions, an international color consortium (ICC) profile by characterizing each color region using a spectrophotometer. As noted above, in some examples, generating the ICC profiles may comprise using the spectrophotometer in a transmission mode.

The generated ICC color profiles can be applied to images that are to be printed in a “sandwich printing” mode, whereby a first image and a second image are printed on opposite sides of a separating medium, to enable an improved result from the combination of colors in the front and back images. Furthermore, profiles can be selected and applied to the image to be printed on the back side of the separating medium such that less print agent may be used to achieve the intended color from the combination of the front and back images.

In some examples, the generated ICC color profiles may be stored in a storage medium (e.g. a memory) in or associated with a particular print apparatus. A different set of ICC color profiles may be generated (and optionally stored) in respect of multiple print modes of a print apparatus and/or in respect of multiple sets of colors. For example, a set of 125 ICC color profiles may be generated and stored in a memory accessible by a print apparatus for use in a first (e.g. high quality) print mode, while a set of 216 ICC color profiles may be generated and stored in the memory for use in a second (e.g. higher quality) print mode. Characterization of the colors may be performed (e.g. according to the method 200) for example, at or soon after manufacturer of a print apparatus, when the print apparatus is installed, or at any time prior to use of the print apparatus in an appropriate (e.g. “sandwich printing”) print mode. In some examples, a set or sets of ICC profiles may be provided to a print apparatus (e.g. installed in a print apparatus (at a customer site) for use in a “sandwich printing” print mode.

As noted above, the separating medium used to separate the first image (i.e. the front image) and the second image (i.e. the back image) may be different depending on the print apparatus used to perform the printing operation and/or the printing technique used. In some examples, the separating medium may comprise a printable substrate, such that the plurality of color regions 104 are printed on a first side (e.g. side A) of the printable substrate and the plurality of patches 106 are printed on the second side (e.g. side B) of the printable substrate. The printable substrate may, in some examples, comprise a transparent or semi-transparent (or semi-opaque substrate) substrate. In other examples, the separating medium may comprise a layer of print agent (e.g. white print agent), such that the plurality of patches 106 are printed on a printable substrate, the layer of print agent is printed onto the plurality of patches, and the plurality of color regions 104 are printed onto the layer of print agent. The layer of print agent may be printed in such a way (e.g. having an appropriate density or thickness) that light is able to pass through the patches 106, the print agent and the color regions 104.

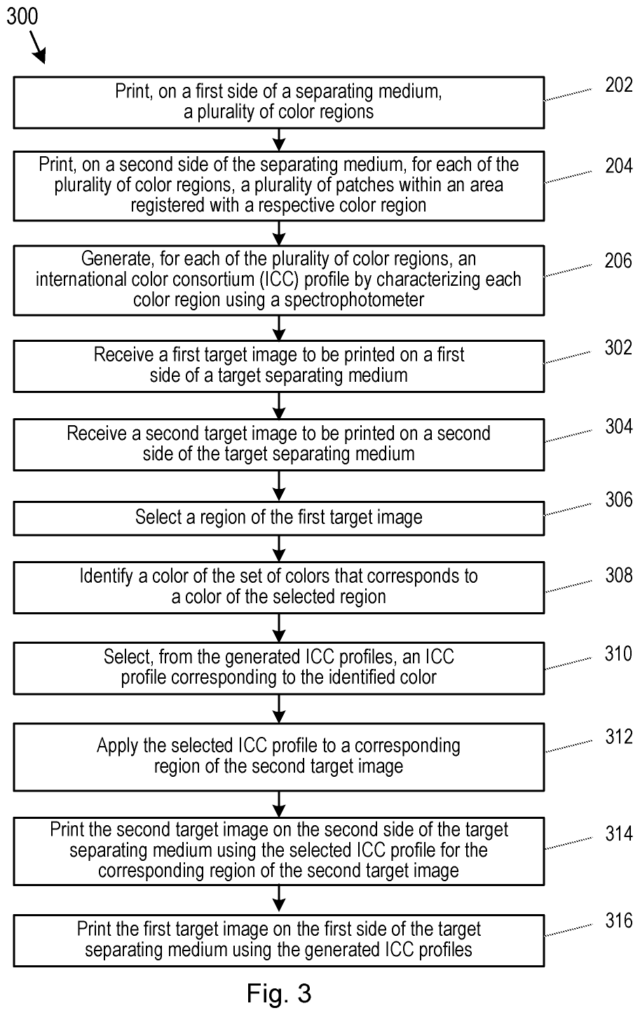

ICC color profiles that have been generated for a set of color combinations (e.g. using the method 200 described above) may be applied to an image that is to be printed as part of a “sandwich print mode” printing operation. Examples of the application of the generated ICC color profiles are described below with reference to FIGS. 3 to 5.

FIG. 3 is a flowchart of a further example of a method 300, which may be considered to be a color management method. The method 300 may include a block or blocks of the method 200 described above. The method 300 comprises, at block 302, receiving a first target image to be printed on a first side of a target separating medium. As described above, the target separating medium may comprise a printable substrate or a layer of white print agent. At block 304, the method 300 comprises receiving a second target image to be printed on a second side of the target separating medium. The first target image and/or the second target image may be received in the form of image data defining the images that are to be printed on the first side and the second side respectively of the separating medium. In some examples, the first target image and/or the second target image may be received in the form of an image file that can be processed by a computing device and/or a print apparatus.

The method 300 comprises, at block 306, selecting a region of the first target image. As described in greater detail below, various approaches may be taken when selecting a region or determining which region to select. In a first approach, an area may be selected based on a predominant color in the first target image while, in a second approach, the region to be selected may comprise a pixel of the first target image.

At block 308, the method 300 comprises identifying a color of the set of colors that corresponds to a color of the selected region. Each of the ICC profiles generated for the color patches on the second side has an associated color of the set of colors on the first side. Therefore, each of the ICC profiles may be identifiable with reference to an associated color of the set of colors. In some examples, the color of the selected region may correspond exactly to (i.e. match with) a color in the set of colors. In other examples, where the color of the selected region does not match exactly with a color in the set of colors, a color may be identified in the set of colors that corresponds most closely to the color of the selected region. Various techniques may be used to determine color differences and the “distances” between colors, as described in an example below.

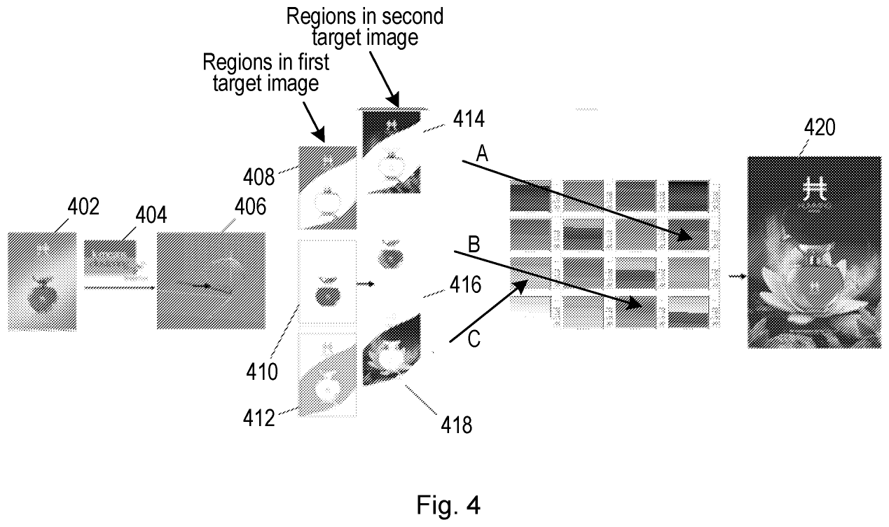

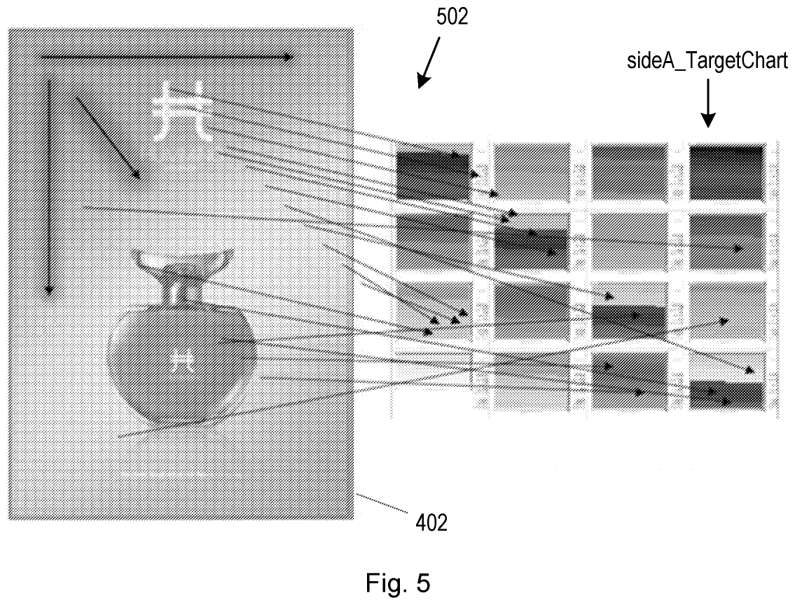

The method 300 comprises, at block 310, selecting, from the generated ICC profiles, an ICC profile corresponding to the identified color. At block 312, the method 300 comprises applying the selected ICC profile to a corresponding region of the second target image. Blocks 310 and 312 are discussed in greater detail below with reference to FIGS. 4 and 5. The corresponding region of the second target image is registered with the selected region of the first target image. In other words, the corresponding region of the second target image is the region that appears behind the selected region of the first target image, such that, when the images are back illuminated, a viewer is able to view a combination of the color of the corresponding region of the second target image and a color of the selected region of the first target image.

One of the generated ICC color profiles may be selected in respect of multiple selected regions of the first target image and applied to corresponding selected regions of the second target image. As is apparent from the discussion below, a generated ICC color profile may, in some examples, be applied to each pixel of the second target image.

Once ICC profiles have been applied to the intended regions of the second target image, the first target image and the second target image may be printed using a “sandwich printing” print mode. Thus, at block 314, the method 300 may comprise printing the second target image on the second side of the target separating medium using the selected ICC profile for the corresponding region of the second target image. At block 316, the method 300 may comprise printing the first target image on the first side of the target separating medium using the generated ICC profiles.

In examples where the first target image and the second target image are the same, ICC color profiles may not be generated and applied to the second target image since the same colors may be used for corresponding regions of the first target image and the second target image. In such an example, a viewer is unlikely to see any combination of different colors resulting from the combination of the first and second target images. Thus, the method is disclosed herein may be applicable to cases where the first and second target images are different. In some examples, therefore, the first target image to be printed on the first side of the target separating medium may be different to the second target image to be printed on the second side of the target separating medium.

Various example techniques of applying the generated ICC profiles to an image to be printed are now discussed with reference to Figures of 4 and 5. A first technique, which may be referred to as an area-based approach, is shown in FIG. 4.

FIG. 4 is an illustration of an approach for applying generated color profiles to an image according to the area-based method. In the area-based approach, the selection of a region of the first target image (e.g. block 306 of the method 300) is based on regions of predominant color within the first target image. In FIG. 4, a first target image 402 that is to be printed on a first side (e.g. side A) of a separating medium is received (block 302). According to examples of the area-based approach, a region is selected within the first target image that has a color that is predominant within the first target image. Additional regions may be selected that have other colors that are predominant within the first target image. According to some examples, regions of predominant color may be identified using clustering techniques, such as a clustering algorithm. For example, a k-means clustering algorithm may be applied at 404. k-means clustering is a vector quantization approach that can be used to group regions (e.g. pixels) into clusters, such as clusters of like colors.

Once pixels have been identified that have colors that are the same as or similar to (e.g. within a defined color range of) a predominant color of the first target image, a centroid of the colors may be determined at 406. By using clustering algorithms, such as k-means clustering, the entire image can be divided into clusters of pixel regions having colors that are the same as or similar to (e.g. within a defined color range of) the centroid based on their distance from the centroid of a given cluster. This distance can be calculated using various algorithms. For example, for k-means clustering, the least square Euclidian distance may be used. In other examples, other distance metrics may be used. The color at the centroid of the group colors may be considered to be the first predominant color of the first target image. Additional predominant colors (e.g. a second predominant color and a third predominant color) may also be determined.

Selecting a region (block 306 of the method 300) may therefore comprises selecting a region or group of pixels having a particular one the predominant colors of the first target image or having a color similar to (e.g. within a defined color range of) the particular predominant color. In the example shown in FIG. 4, pixels are identified within a first region 408 that have a predominantly green color, pixels are identified within a second region 410 that have a predominantly orange color, and pixels are identified within a third region 412 that have a predominantly grey color.

For each of the identified predominant colors (e.g. green, orange and grey in this example) the corresponding ICC color profile is selected from the set of generated ICC profiles (block 206 of the method 200), as indicated by the arrows A, B and C. For example, for the first region 408 of the first target image 402, an ICC profile corresponding to the particular green color that is predominant in the first target image is selected. The selected ICC profile is then applied to the corresponding region in the second target image. In other words, those areas (e.g. pixels) in the second target image that correspond to (i.e. are registered with) the region of a particular predominant color in the first target image are identified, and the selected ICC profile is applied to pixels within those areas. FIG. 4 shows a first corresponding region 414 of the second target image (i.e. that corresponds with the first region 408 of the first target image 402), a second corresponding region 416 of the second target image (i.e. that corresponds with the second region 410 of the first target image 402) and a third corresponding region 418 of the second target image (i.e. that corresponds with the third region 412 of the first target image 402). A resulting image 420 is formed when a backlight is used to illuminate the first and back target images.

FIG. 5 is an illustration of an approach for applying generated color profiles to an image according to the pixel-based method. In the pixel-based approach, the selection of a region in the first target image 402 (e.g. block 306 of the method 300) is performed on a pixel-by-pixel basis. Thus, each region comprises a pixel of the image, and an ICC profile is selected for an individual pixel (illustrated at 502). The process is repeated for each pixel in the image. In contrast with the area-based approach, therefore, in which different ICC profiles are selected and allocated to just a few regions in the first target image, the pixel-based approach involves the selection and allocation of an ICC profile to each and every pixel in the first target image. Therefore, the area-based approach may be performed relatively more quickly than the pixel-based approach. However, the pixel-based approach may take longer to perform, but may provide a more perceptually acceptable result, with fewer visible discontinuities than the area-based approach.

Whether the area-based approach or the pixel-based approach is used, a similar technique for identifying and applying the ICC profile in respect of the selected region may be used. In an example, for a first target image of size (m*n) pixels, where m represents the number of pixel rows and n represents the number of pixel columns, pixels may be dealt with in turn. The pixel (1, 1) of the first image (i.e. the side A image) may be selected and converted to a generic front-lit profile of the first image, then to the CIELAB color space using the absolute colorimetry of the generic profile of the first image. In other words, the first image has just one associated ICC profile, and this is referred to as the generic profile. Each of the ICC color profiles generated at block 206 of the method 200 may be identifiable by the RGB combination that is present in the corresponding pixel of the first target image. The pixel value may be converted from RGB into the CIELAB color space using the absolute colorimetry of the ICC profile associate with the first image. The converted CIELAB value of pixel (1, 1) of the first image is searched for in the identifiers of the ICC profiles generated at block 206. The ICC profile having the smallest color difference (e.g. using the International Commission on Illumination's standard CIEDE2000) from the color of the pixel is assigned to the pixel. A profile identifier (e.g. identification number) is allotted to the pixel (1, 1) and the process is repeated for the next pixel value. In the area-based approach, the same profile identifier may be allotted to all pixels within the group pixels having the same predominant color while, in the pixel-based approach, every pixel may be considered separately.

The profile identifiers allotted to each pixel form a profile map for the second target image (i.e. the image to be printed on the second side/backside of the separating medium). Once profile identifiers have been allotted to all of the pixels in the first target image, they are applied to all of the pixels (e.g. from pixel (1, 1) to pixel (m, n) in the second target image.

Once the ICC profiles have been applied to the corresponding regions (e.g. the regions 414, 416, 418 in FIG. 4 or to all of the pixels in the pixel-based approach), image data defining the appropriate ICC profiles to be used for each pixel in each region can be provided to a print apparatus for printing. Once the first target image and the second target image have been printed either side of the separating medium, and the images are illuminated by a backlight, a resulting image 420 is, which is a combination of the colors as defined by the selected ICC profiles.

Any of the printing processes described herein may be accomplished by any suitable printer, such as one suitable for “sandwich printing”. In one example, the printing process may involve a raster image processor (“RIP”).

In some example, an RIP may be a component used in a printing system which produces a raster image also known as a bitmap. Such a bitmap is used by a later stage of the printing system to produce the printed output. The input may be a page description in a high-level page description language such as a bitmap of higher or lower resolution than the output device. The RIP may apply either smoothing or interpolation algorithms to the input bitmap to generate the output bitmap. An RIP may be implemented either as a software component of an operating system or as a firmware program executed on a microprocessor inside a printer, though for high-end typesetting, standalone hardware RIPs are sometimes used.

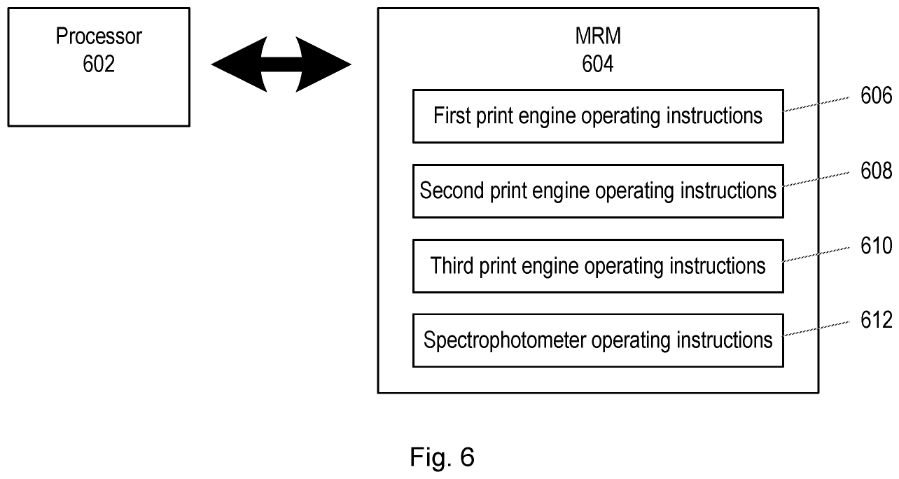

In some examples, some blocks of the methods disclosed herein may be performed or implemented using a processor. In addition to the methods 200, 300 described above, the present disclosure also provides a machine-readable medium. FIG. 6 is a schematic illustration of an example of a processor 602 in communication with a machine-readable medium 604. The machine-readable medium 604 comprises instructions (e.g. first print engine operating instructions 606) which, when executed by a processor, such as the processor 602, cause the processor to operate a print engine to print, on a first side of a first separating medium, a first patch of a first color of a set of colors and a second patch of a second color of the set of colors. The print engine may comprise, or include, and RIP as discussed above.

The machine-readable medium 604 may comprise instructions (e.g. second print engine operating instructions 608) which, when executed by the processor 602, cause the processor to operate a print engine to print, on a second side of the first separating medium, at a location registered with the first patch, a third patch of the first color and a fourth patch of the second color.

The machine-readable medium 604 may comprise instructions (e.g. third print engine operating instructions 610) which, when executed by the processor 602, cause the processor to operate a print engine to print, on the second side of the first separating medium, at a location registered with the second patch, a fifth patch of the first color and a sixth patch of the second color.

In other words, patches of the first and second color (i.e. the third and fourth patches) are printed in an area of the second side that falls within (e.g. is contained within) the area in which the first patch (of the first color) is printed on the first side, and patches of the first and second color (i.e. the fifth and sixth patches) are also printed in an area of the second side that falls within (e.g. is contained within) the area in which the second patch (of the second color) is printed on the first side. Put another way, the third and fourth patches are printed behind the first patch, and the fifth and sixth patches (which have the same colors as the third and fourth patches respectively) are printed behind the second patch.

The machine-readable medium 604 may comprise instructions (e.g. spectrophotometer operating instructions 612) which, when executed by the processor 602, cause the processor to operate a spectrophotometer to generate a set of international color consortium (ICC) profiles for the first side by characterizing the first patch and the second patch.

Once the ICC profiles have been generated, they may be used by a print apparatus, or stored (e.g. installed into a print apparatus) for later use. Thus, in some examples, the machine-readable medium 604 may comprise instructions which, when executed by the processor 602, cause the processor to provide the generated set of ICC profiles for storage or for use by a print apparatus to print a first image on a first side of a second separating medium and a second image on the second side of the second separating medium according to the generated set of ICC profiles. Thus, the first separating medium may comprise the separating medium used for printing the various color patches and generating the ICC profiles, while the second separating medium may comprise the separating medium used for printing the first and second images based on the generated ICC profiles.

The machine-readable medium 604 may, in some examples, comprise instructions which, when executed by the processor 602, cause the processor to receive a first image to be printed on a first side of a second separating medium. The machine-readable medium 604 may, in some examples, comprise instructions which, when executed by the processor 602, cause the processor to receive a second image to be printed on a second side of the second separating medium. The first image and the second image may be received in the form of image data (e.g. first image data and second image data) in a format that can be interpreted by the processor.

The machine-readable medium 604 may, in some examples, comprise instructions which, when executed by the processor 602, cause the processor to select a region of the first image. As discussed above, the selection of a region in the first image may be based on the area-based approach or on the pixel-based approach.

The machine-readable medium 604 may, in some examples, comprise instructions which, when executed by the processor 602, cause the processor to identify a color of the set of colors that corresponds to a color of the selected region. The machine-readable medium 604 may, in some examples, comprise instructions which, when executed by the processor 602, cause the processor to select, from the set of generated ICC profiles, an ICC profile corresponding to the identified color. In some examples, the machine-readable medium 604 may comprise instructions which, when executed by the processor 602, cause the processor to apply the selected ICC profile to a corresponding region of the second image. The corresponding region of the second image may comprise a region that is registered with the selected region of the first image. For example, the corresponding region of the second image, once printed, appears behind the selected region of the first image.

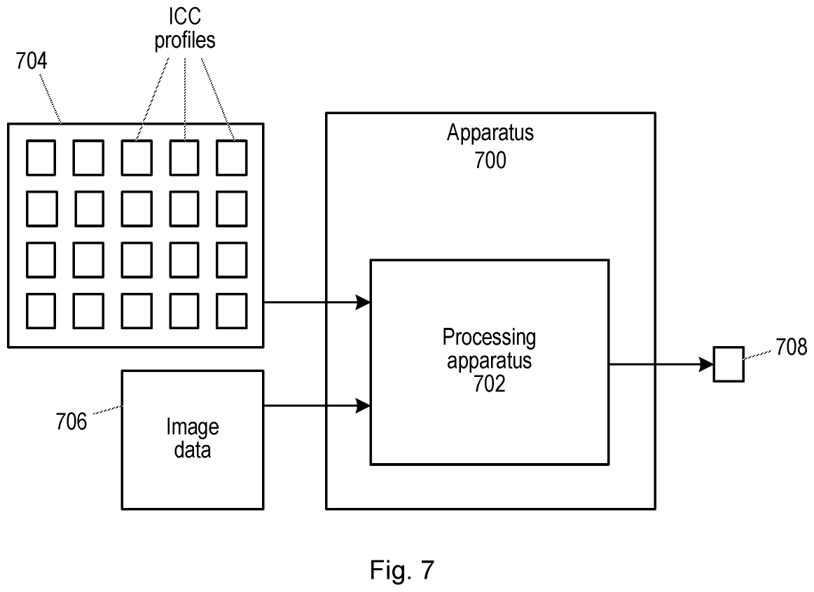

Examples of the present disclosure also provides an apparatus. FIG. 7 is a schematic station of an example of an apparatus 700. The apparatus 700 comprises a processing apparatus 702. In some examples, the purchasing apparatus 702 may comprise, or be similar to the processor 602 discussed above. The processing apparatus 702 may be to receive an international color consortium (ICC) profile 704 for each of a plurality of color regions printed on a first side of a first separating medium, each region being of a different color of a set of colors, wherein, a second side of the first separating medium includes, for each of the plurality of color regions, a plurality of patches within an area registered with a respective color region, each patch being a different one of the set of colors.

The processing apparatus 702 may also be to receive image data 706 defining a first image to be printed on a first side of a second separating medium and a second image to be printed on a second side of the second separating medium. The processing apparatus 702 may also be to select a first region of the first image. The processing apparatus 702 may also be to identify a first color of the set of colors that corresponds to a color of the selected first region. The processing apparatus 702 may also be to select, from the received ICC profiles, a first ICC profile 708 corresponding to the identified first color. The processing apparatus 702 may also be to apply the selected first ICC profile 78 to a first region of the second image that is registered with the selected first region of the first image.

In some examples, the processing apparatus 702 may also repeat the region selection and subsequent processes for other regions in the first image. Specifically, the processing apparatus may be to select a second region of the first image. The processing apparatus 702 may also be to identify a second color of the set of colors that corresponds to a color of the selected second region. select, from the received ICC profiles, a second ICC profile corresponding to the identified second color. The processing apparatus 702 may also be to apply the selected second ICC profile to a second region of the second image that is registered with the selected second region of the first image.

In examples where the area-based approach is used, the selection of regions may be based on the predominant colors in the first image. Thus, the first region and the second region may, in some examples, comprise regions of the first image regions having, respectively, the first and second most commonly occurring colors in the first image.

In examples where the pixel-based approach is used, the selection of regions may be performed on a pixel by pixel basis. Thus, the processing apparatus may be to, successively, for each pixel in the first image: select a pixel of the first image; identify a color of the set of colors that corresponds to a color of the selected pixel; select, from the received ICC profiles, an ICC profile corresponding to the identified color; and apply the selected ICC profile to a pixel of the second image that is registered with the selected pixel of the first image.

Examples of the present disclosure provide a mechanism by which a set of ICC color profiles may be generated that take account of all possible combinations in a set of colors. By applying an appropriate ICC profile from the set of generated profiles to an image to be printed as part of a “sandwich printing” or “day and night” print operation, the resulting image may have a perceptually more acceptable color, resulting from the combination of colors from the front and back images.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A color management method comprising:
printing, on a first side of a separating medium, a plurality of color regions, each region being of a different color of a set of colors;
printing, on a second side of the separating medium, for each of the plurality of color regions, a plurality of patches within an area registered with a respective color region, wherein each patch has a different one of the set of colors; and
generating, for each of the plurality of color regions, an international color consortium (ICC) profile by characterizing each color region using a spectrophotometer.

2. A method according to claim 1, further comprising:
receiving a first target image to be printed on a first side of a target separating medium;
receiving a second target image to be printed on a second side of the target separating medium;
selecting a region of the first target image;
identifying a color of the set of colors that corresponds to a color of the selected region;
selecting, from the generated ICC profiles, an ICC profile corresponding to the identified color; and
applying the selected ICC profile to a corresponding region of the second target image;
wherein the corresponding region of the second target image is registered with the selected region of the first target image.

3. A method according to claim 2, wherein selecting a region of the first target image comprises:
applying a clustering algorithm to identify a predominant color in the first target image; and
selecting a region of the first target image having the identified predominant color.

4. A method according to claim 2, wherein selecting a region of the first target image comprises:
selecting a first pixel of the first target image.

5. A method according to claim 2, further comprising:
printing the second target image on the second side of the target separating medium using the selected ICC profile for the corresponding region of the second target image;
printing the first target image on the first side of the target separating medium using the generated ICC profiles.

6. A method according to claim 2, wherein the first target image to be printed on the first side of the target separating medium is different to the second target image to be printed on the second side of the target separating medium.

7. A method according to claim 1, wherein generating the ICC profiles comprises using the spectrophotometer in a transmission mode.

8. A method according to claim 1, wherein the separating medium comprises a medium selected from a group comprising:
a printable substrate, such that the plurality of color regions are printed on a first side of the printable substrate and the plurality of patches are printed on the second side of the printable substrate; and
a layer of white print agent, such that the plurality of patches are printed on a printable substrate, the layer of white print agent is printed onto the plurality of patches, and the plurality of color regions are printed onto the layer of white print agent.

9. A machine-readable medium comprising instructions which, when executed by a processor, cause the processor to:
operate a print engine to print, on a first side of a first separating medium, a first patch of a first color of a set of colors and a second patch of a second color of the set of colors;
operate a print engine to print, on a second side of the first separating medium, at a location registered with the first patch, a third patch of the first color and a fourth patch of the second color;
operate a print engine to print, on the second side of the first separating medium, at a location registered with the second patch, a fifth patch of the first color and a sixth patch of the second color; and
operate a spectrophotometer to generate a set of international color consortium (ICC) profiles for the first side by characterizing the first patch and the second patch.

10. A machine-readable medium according to claim 9, comprising instructions which, when executed by a processor, cause the processor to:
provide the generated set of ICC profiles for storage or for use by a print apparatus to print a first image on a first side of a second separating medium and a second image on the second side of the second separating medium according to the generated set of ICC profiles.

11. A machine-readable medium according to claim 9, comprising instructions which, when executed by a processor, cause the processor to:
receive a first image to be printed on a first side of a second separating medium;
receive a second image to be printed on a second side of the second separating medium;
select a region of the first image;
identify a color of the set of colors that corresponds to a color of the selected region;
select, from the set of generated ICC profiles, an ICC profile corresponding to the identified color; and
apply the selected ICC profile to a corresponding region of the second image;
wherein the corresponding region of the second image is registered with the selected region of the first image.

12. An apparatus comprising:
a processing apparatus to:
receive an international color consortium (ICC) profile for each of a plurality of color regions printed on a first side of a first separating medium, each region being of a different color of a set of colors, wherein, a second side of the first separating medium includes, for each of the plurality of color regions, a plurality of patches within an area registered with a respective color region, each patch being a different one of the set of colors;
receive image data defining a first image to be printed on a first side of a second separating medium and a second image to be printed on a second side of the second separating medium;
select a first region of the first image;
identify a first color of the set of colors that corresponds to a color of the selected first region;
select, from the received ICC profiles, a first ICC profile corresponding to the identified first color; and
apply the selected first ICC profile to a first region of the second image that is registered with the selected first region of the first image.

13. An apparatus according to claim 12, wherein the processing apparatus is to:
select a second region of the first image;
identify a second color of the set of colors that corresponds to a color of the selected second region;
select, from the received ICC profiles, a second ICC profile corresponding to the identified second color; and
apply the selected second ICC profile to a second region of the second image that is registered with the selected second region of the first image.

14. An apparatus according to claim 13, wherein the first region and the second region comprise regions of the first image regions having, respectively, the first and second most commonly occurring colors in the first image.

15. An apparatus according to claim 12, wherein the first region comprises a first pixel of the first image, and wherein the processing apparatus is to:
successively, for each pixel in the first image:
select a pixel of the first image;
identify a color of the set of colors that corresponds to a color of the selected pixel;
select, from the received ICC profiles, an ICC profile corresponding to the identified color; and
apply the selected ICC profile to a pixel of the second image that is registered with the selected pixel of the first image.
